(19) United States
(12) Patent Application Publication
(10) Pub. No.: US 2001/0001927 A1
(43) Pub. Date: May 31, 2001

(54) Personal heat index indicator

(76) Inventor: Faun Jackson JR., Licking, MO (US)

Correspondence Address: Joseph L. Johnson, LATHROP & GAGE L.C.,, 1845 S. National Ave., P.O. Box 4288, Springfield, MO, 65808-4288, US

(21) Appl. No.: 09/758,639

(22) Filed: Jan. 11, 2001

Related U.S. Application Data
(63) Continuation-in-part of application No. 09/034,835, filed on Mar. 4, 1998, now abandoned.

(51) Int. Cl. G01N 5/02

(52) U.S. Cl. 73/335.02; 73/29.04; 340/602

(57) ABSTRACT

A device for determining the ambient heat index and communicating that information to a user, the device having a housing member, a control mechanism, and a power source. The control mechanism includes a microprocessor, an air temperature measuring device, and a relative humidity measuring device, wherein the air temperature measuring device and the relative humidity measuring device respectively determine the user's ambient air temperature and ambient relative humidity and communicate that information real time to the microprocessor for determination of the heat index. The control mechanism has a display mechanism for displaying the heat index, and another display mechanism for displaying the ambient temperature and the ambient relative humidity. Switches permit manual operation of activation of the display mechanisms. The control mechanism may also include a signaling device for signaling the user when the ambient heat index reaches a certain predetermined condition, and an attaching mechanism for attaching the housing member to the user.

This is a Continuation-in-Part Application, pursuant to 37 C.F.R. § 1.53(b), from co-pending U.S. application Ser. No. 09/034,835 filed Mar. 4, 1998

### BACKGROUND OF THE INVENTION

1 . Field of the Invention.

The present invention relates to a heat index calculator that can easily be carried by a person on a key chain, attached to a watch band or bracelet, etc., and, in particular without limitation, to a portable heat index indicator for providing important atmospheric information to individuals, such as the elderly and recreational athletes, who should be aware of the temperature and heat index. The invention will provide an audible warning when the heat index increases to a level which may be dangerous to a previous safety.

2. Description of the Related Art.

Scientists at the National Oceanic and Atmospheric Administration estimate that heat waves accompanied by high humidity kill approximately 150 people each year in the United States alone. While air temperature alone can create health risks for the elderly, physically active persons, and those with certain health conditions, high temperatures combined with high humidity greatly increase the associated dangers. Specifically, there are levels of temperature and humidity which substantially endanger a person's health and safety. When temperature and humidity increase to a point where health concerns arise, it would be beneficial to have ready access to the heat index and to be warned, audibly or otherwise, of the corresponding dangerous condition.

The heat index, which is a function of ambient air temperature and the relative humidity, is sometimes referred to as the apparent temperature and can be readily determined by referring to the following Table 1 provided by the National Weather Service:

| Relative | Air Temperature (° F.) | | | | | | | | | | |
|---|---|---|---|---|---|---|---|---|---|---|---|
| Humidity (%) | 70 | 75 | 80 | 85 | 90 | 95 | 100 | 105 | 110 | 115 | 120 |
| 0 | 64 | 69 | 73 | 78 | 83 | 87 | 91 | 95 | 99 | 103 | 107 |
| 10 | 65 | 70 | 75 | 80 | 85 | 90 | 95 | 100 | 105 | 111 | 116 |
| 20 | 66 | 72 | 77 | 82 | 87 | 93 | 99 | 105 | 112 | 120 | 130 |
| 30 | 67 | 73 | 78 | 84 | 90 | 96 | 104 | 113 | 123 | 135 | 148 |
| 40 | 68 | 74 | 79 | 86 | 93 | 101 | 110 | 123 | 137 | 151 | |
| 50 | 69 | 75 | 81 | 88 | 96 | 107 | 120 | 135 | 150 | | |
| 60 | 70 | 76 | 82 | 90 | 100 | 114 | 132 | 149 | | | |
| 70 | 70 | 77 | 85 | 93 | 106 | 124 | 144 | | | | |
| 80 | 71 | 78 | 86 | 97 | 113 | 136 | | | | | |
| 90 | 71 | 79 | 88 | 102 | 122 | | | | | | |
| 100 | 72 | 80 | 91 | 108 | | | | | | | |

TABLE. Apparent Temperature (° F.) as a function of Relative Humidity (%) and Air Temperature (° F.) For example, the above TABLE discloses that for a situation wherein the ambient air temperature is 95 ° F. and the relative humidity is eighty percent, the heat index or apparent temperature is 136° F.!

At the present time, there are no known devices available which a person can conveniently wear or carry with them and which can determine the heat index directly from measurements of the ambient temperature and relative humidity.

Due to the potential harmful effects of heat exhaustion, particularly for the elderly and for those engaged in physical activity, what is needed is ready access to real-time information regarding the ambient air temperature as well as the apparent temperature, or heat index. What is also needed is a light weight, portable device that can be carried by an individual at all times when potential heat exhaustion is a concern. What is further needed is such a device that, at predetermined levels of temperature and humidity when the combination thereof constitutes a heat index that presents a potential danger to human safety, produces an audible or other type of warning signal to alert the wearer of the impending harm.

At this time, there are no known devices on the market which perform the calculations necessary to derive the heat index from the ambient air temperature and ambient relative humidity, and which a person can conveniently wear on their person.

### SUMMARY OF THE INVENTION

An improved device is provided for determining the heat index, the device including a housing member, a control mechanism connected to the housing member, and a power source for operating the control mechanism, wherein the control mechanism is configured to operatively determine and communicate real time to a user the heat index of the user's ambient atmosphere. The control mechanism includes a microprocessor, an air temperature measuring device, and a relative humidity measuring device, wherein the air temperature measuring device and the relative humidity measuring device are configured to respectively determine the user's ambient air temperature and ambient relative humidity and communicate same real time to the microprocessor. The housing member includes a slotted air inlet for exposing the air temperature measuring device and the relative humidity measuring device to the ambient atmosphere.

The control mechanism may also include a heat index display mechanism, connected to the microprocessor for displaying the heat index. An optional heat index display switch permits manual activation of displaying the heat index on the heat index display mechanism.

The control mechanism may also include a temperature/relative humidity display mechanism, connected to the microprocessor for displaying the ambient temperature and the ambient relative humidity. An optional temperature/relative humidity display switch permits manual activation of displaying the ambient temperature and ambient relative humidity on the temperature/relative humidity display mechanism.

The control mechanism may also include a signaling device for signaling the user when the ambient heat index reaches a certain predetermined condition. The signaling device may be configured to provide an audible signal and/or a vibrational signal to the user.

The device may also include an attaching mechanism for attaching the housing member to the user.

The principal objects and advantages of the invention include: providing a device that is a personal index indicator; providing such a device that is portable; providing such a device that is of a size which can be attached to a wearer such as to a watch band, bracelet, key chain, or the like; and providing such a device that is accurate, relatively inexpensive to manufacture, is beneficial to the wearer's health and safety, and is well suited for its intended purposes.

Other objects and advantages of the present invention will become apparent from the following description taken in conjunction with the accompanying drawings, which constitute a part of this specification and wherein are set forth exemplary embodiments of the present invention to illustrate various objects and features thereof.

### BRIEF DESCRIPTION OF THE DRAWINGS

FIG. 1 is a perspective view of a personal heat index indicator constructed in accordance with the present invention.

FIG. 2 is a top plan view of the personal heat index indicator, showing the personal heat index indicator attached to a user's watch band.

FIG. 3 is a schematic diagram of the personal heat index indicator, showing the preferred electrical circuit configuration of the present invention.

FIG. 4 is an electrical block diagram, showing an alternate electrical circuit configuration and alternate display.

FIG. 5 is an internal view of the device, showing electrical component placement.

### DETAIL DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

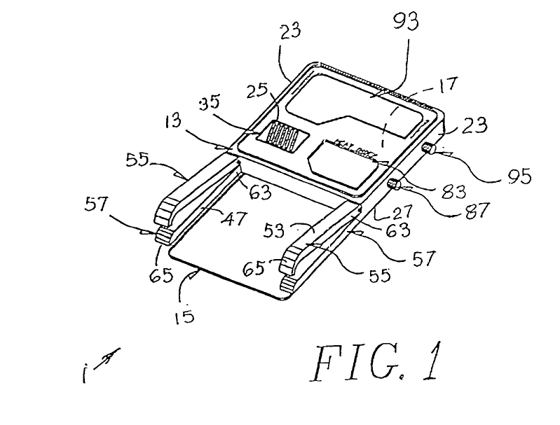

The reference numeral 1 generally refers to a personal heat index indicator in accordance with the present invention, as shown in FIGS. 1 through 3. The heat index indicator 1 generally comprises a housing member 13, an attaching mechanism 15, and a control mechanism 17.

The housing member 13 generally has side walls 23, a top wall 25, and a bottom wall 27 defining an internal chamber 33 within the housing member 13. FIG. 1 shows the side walls 23 providing the housing member 13 with a substantially rectangular configuration. It is to be understood, however, that the configuration of the housing member 13 may be oval, circular, hexagonal, octagonal, or any other suitable configuration. The housing member 13 has an air inlet 35 configured to operatively allow entry of ambient air into the internal chamber 33.

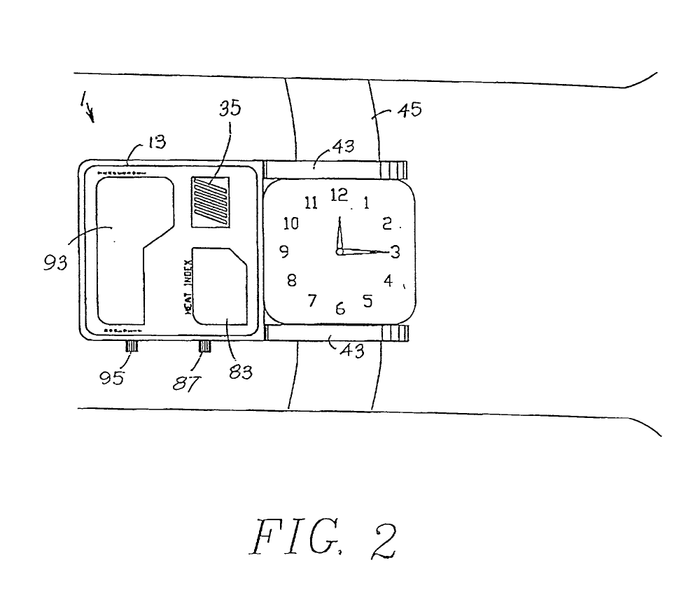

The attaching mechanism 15, which is connected to the housing member 13, is configured to operatively attach the personal heat index indicator about a member of a user's body such as the wrist, to an article of the user's wearing apparel, or other suitable attaching arrangement. For example, the attaching mechanism 15 may comprise a pair of attachment clips 43 for attaching the personal heat index indicator 1 to a wristband 45 as shown in FIG. 2. The attachment clips 43 generally include a first clip 47 and a second clip 53 substantially parallel to the first clip 47. Each of the first clip 47 and the second clip 53 further include a top arm 55 and a bottom arm 57. The top arm 55 and the bottom arm 57 each have a first end 63 and a second end 65. The first end 63 of each of the top arms 55 is pivotally connected to the housing member 13, and the first end 63 of each of the bottom arms 57 is fixedly connected to the housing member 13 such that the top arms 55 can be actuated generally perpendicularly to a plane formed by the two bottom arms 57. The second end 65 of each of the top arms 55 is mated to the second end 65 of the corresponding bottom arm 57, as shown in FIG. 1, such that when the top arms 55 are actuated downwardly, they provide a secure closure with respect to their corresponding bottom arms 57.

The use of attachment clips 43 for attaching the personal heat index indicator 1 to a wristband 45 by sliding the bottom arms 57 under the wristband 45 and pressing the top arms 55 downwardly to latch the personal heat index indicator 1 onto the wristband 45 is shown in FIG. 2. It is to be understood, however, that any other suitable method of securing the personal heat index indicator 1 is within the nature and scope of the present invention including, without limitation, a hook and loop fastener arrangement for placement on items of clothing, a spring loaded clip for attachment to a zipper pull or key chain, an arrangement wherein the personal heat index indicator 1 is sewn into an article of clothing such as a hat or in the fabric of athletic shoes, etc.

The control mechanism 17 includes an air temperature measuring device 73, such as a Model EL-700 RTD temperature sensor as provided by HyCal, Inc. of El Monte, Calif., or other suitable device for measuring ambient air temperature. The control mechanism 17 also includes relative humidity measuring device 75, such as a Model IH-3605 IC humidity sensor as also provided by HyCal, Inc., or other suitable device for measuring ambient relative humidity. Additionally, the control mechanism also includes a microprocessor 77 programmed and configured to combine real-time temperature data provided by the air temperature measuring device 73 with the real-time relative humidity data provided the relative humidity measuring device 75 to determine the ambient heat index/apparent temperature.

The control mechanism 17 also includes a display mechanism 83 appropriately connected to the microprocessor 77 for displaying the heat index resulting from the ambient temperature and relative humidity conditions. The display mechanism 83 may comprise light-emitting diodes, or other suitable, preferably low power display device.

The procedure utilized by the microprocessor 77 for determining the heat index from the measured temperature and relative humidity data may be by appropriately applying a preprogrammed formulation known to those skilled in the art, by appropriately extracting data from a lookup table providing heat index as a function of temperature and relative humidity similar to that hereinbefore shown in the TABLE which procedure may include extrapolation for greater accuracy if desired, or any other suitable procedure for determining heat index from the measured temperature and relative humidity data.

A power source 85, such as a small battery similar to those used to power wrist watches that is containable within the internal chamber 33, or other suitable power source, is connected to the control mechanism 17, including the microprocessor 77 and the display mechanism 83, to provide energy for operating the various components of the personal heat index indicator 1.

The personal heat index indicator 1 generally includes a display switch 87 that, when manually depressed, causes the heat index determined by the personal heat index indicator 1 to be displayed on the display mechanism 83. If desired, the personal heat index indicator 1 may include another display mechanism 93, similar to the display mechanism 83, but configured to display the temperature and relative humidity as measured by the air temperature measuring device 73 and the relative humidity measuring device 75. In that event, another display switch 95 is configured to cause the measured ambient air temperature and relative humidity to be displayed by the display mechanism 93 upon manual depression thereof. It is to be understood that either or both of the display switch 87 and the display switch 95 may be omitted if continuous display of the display mechanism 83 and/or the display mechanism 93 is desired.

The personal heat index indicator 1 generally also includes a signaling mechanism 97 for signaling the user when a predetermined heat index condition or level is met. For example, the signaling mechanism 97 may include a transducer for emitting audible sounds designed to alert the user that potentially unsafe ambient conditions exist. The signaling mechanism 97 may be electronically triggered when a predetermined value of heat index condition is calculated and extracted from a lookup table. Alternatively or additionally, particularly for the heating impaired, the signaling mechanism 97 may be configured to physically vibrate when a predetermined heat index condition or level is met, again, to thereby alert the user that potentially unsafe ambient conditions exist. Further, either alternatively or additionally, the signaling mechanism 97 may include a light-emitting mechanism that flashes when a predetermined heat index is reached.

It is to be understood that, preferably, the various components, particularly the air temperature measuring device 73, the relative humidity measuring device 75, and the microprocessor 77, are located within the internal chamber 33 of the housing member 13. With the micro-miniaturization techniques presently available, it is conceivable that the personal heat index indicator I may be incorporated directly into the housing of a wrist watch, thereby allowing display of the pertinent information on the digital display of the watch itself. It is also conceivable that the various components of the personal heat index indicator 1 may be incorporated into the on-board computer system of an automobile.

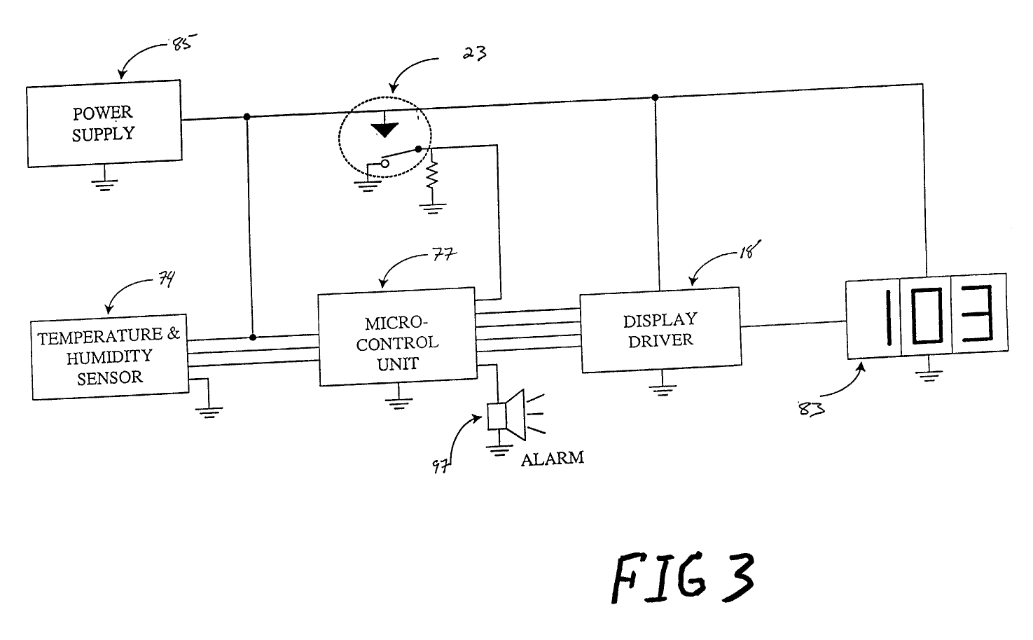

FIG. 3 shows the process and function of the components located within the molded housing. These include a combined air temperature sensing device and a relative humidity sensing device 74, a microcontroller 77 to receive the output of the sensing device and circuit components consisting of a display driver circuit 18 to process the output of the microcontroller 77 into a format usable by the LCD display 83 to present the measured and calculated values from the circuitry in a user-readable form 83. A combined sensor switch 23 allows the user to manually operate the device to display the heat index at the push of a button 95 associated with switch 23. The power source 85 in the preferred embodiment may consist of nickel-cadmium, mercury, or lithium calculator-type batteries, or may consist of a solar cell panel and associated interface circuitry or both. There is no basic difference between the two implementations of the power supply, and the produced configuration would depend upon the intended user and the market demand. A piezoelectric sonic alarm 97 would also be included in the circuitry within the housing.

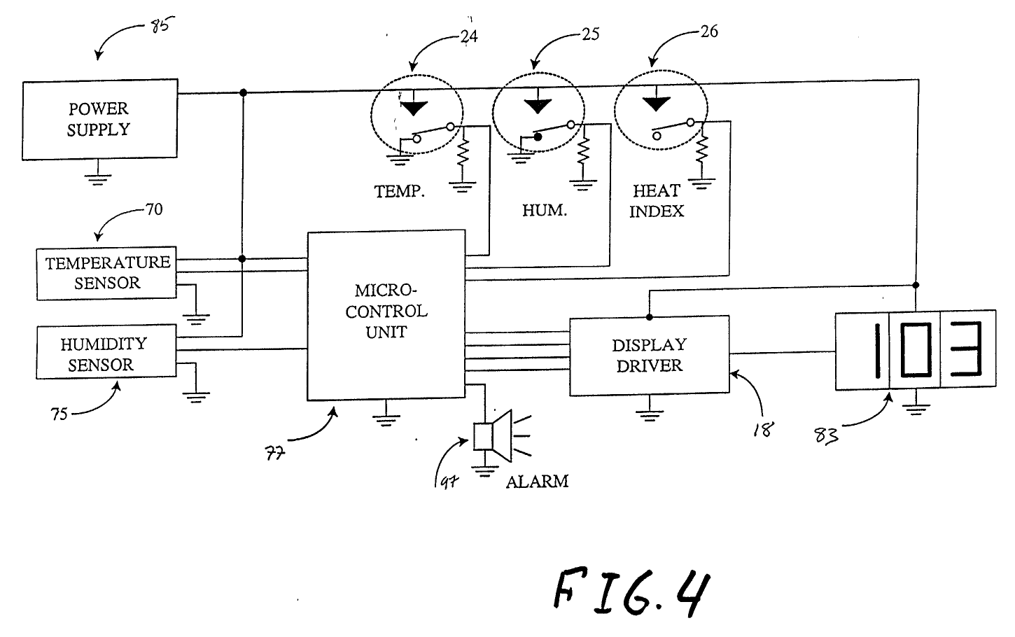

In the preferred embodiment of the instrument, the temperature sensing device 77 and humidity sensing device 75 might be combined in one unit 74 and consist of Vaisala Environmental Measurements part number 17204HM Humichip, or Honeywell MicroSwitch part number HIH-3605 or any similar device which is capable of one-chip sensing of air temperature and relative humidity at low voltages and low power. In alternate embodiments, separate sensors as shown in FIG. 4 could be used. Small, low-power devices for separate measurement of temperature and relative humidity are well known and widely available.

In the preferred embodiment the heat index calculation would be performed by a microcontroller 77 from the very popular 80C51 family. The preferred device would be an87C554 single-chip 8-bit microcontroller which contains a 16 k-by-8 non-volatile OTPEPROM, a 512 -by-8 read/write data memory, five 8-bit input/output (I/O) ports, one 8-bit input port, 2 standard 16-bit timer/event counters, a 15-source 4-priority-level nested interrupt structure, an 8-channel 10-bit analog-to-digital converter (ADC), an on-chip oscillator and timing circuits. The ADC converters would be used to convert the analog voltages from the temperature sensor 73 and humidity sensor 75 for combined unit 74 to the digital format required by the microcontroller. The heat index calculation would be accomplished by comparing the sensor data to the heat index values (as shown in Table 1, Page 2) in a look-up table stored in the microcontroller 77 memory.

The output of the microcontroller 77 would be the heat index numerical value in digital form. A display driver 18 will convert the digital data from the microcontroller 77 into the standard form required by the LCD display 83. A separate output of the microcontroller 77 would be used to energize the piezoelectric sonic alarm 97 at a predetermined value of the heat index.

In an alternate embodiment of the invention, as shown in FIG. 4, the major differences are the use of separate sensors; and the addition of separate switches temperature 24, humidity 25, and heat index 26 for individual selection of the measurement to be observed on the display 83. The alternate embodiment as shown is functionally equivalent to the preferred one.

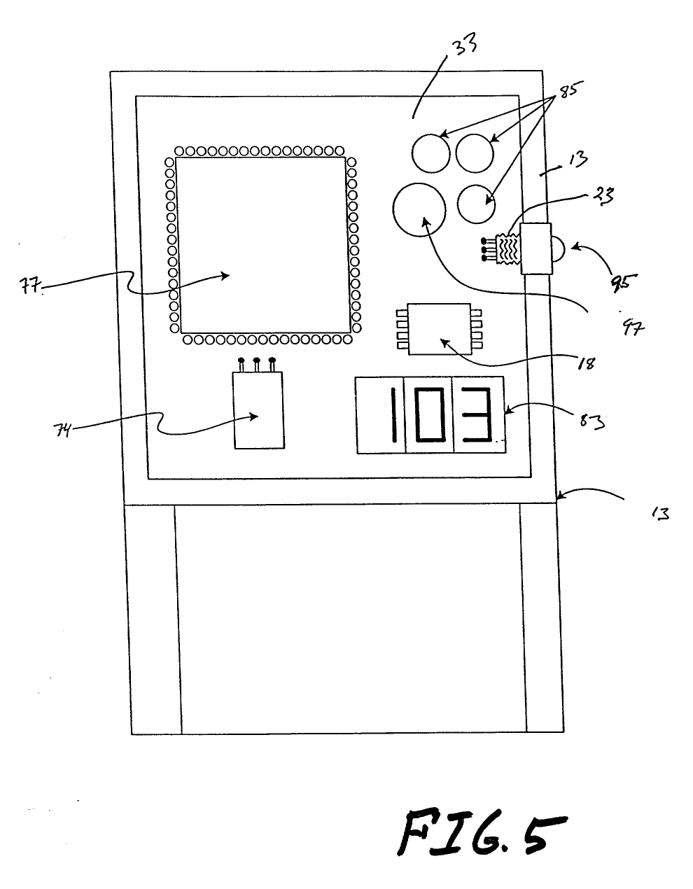

FIG. 5 shows the preferred embodiment of the invention as implemented on a printed circuit board within the component housing. The power supply 85 is shown as 3 separate calculator-type batteries although one lithium cell or the alternate solar cell and interface circuit may be used. All of these options are functionally equivalent and no preference is attached to them other than that dictated by user demand through the market.

In an application of the present invention, ambient air is received through the air inlet 35 and exposed to the air temperature measuring device 73 and the relative humidity measuring device 75, which respectively determine the temperature and the relative humidity thereof. The resultant temperature data and relative humidity date are electronically communicated real-time by the air temperature measuring device 73 and the relative humidity measuring device 75 to the microprocessor 77 which, in turn, determines the heat index corresponding to the communicated temperature data and relative humidity data and communicates those results to the display mechanism 83. Additionally, if appropriate, the microprocessor 77 also activates the signaling device 97.

It is also to be understood that a thermohygrometer can be modified to include a microprocessor as hereinbefore described to provide a heat index readout. Further, a microprocessor can conceivably be added to a combination thermostat humidistat to provide a heat indicator within the nature and scope of the present invention.

Whereas the present invention has been described in relation to the drawings attached hereto, it should be understood that other and further modifications, apart from those shown or suggested herein, may be made within the spirit and scope of this invention.

CLAIMS: What is claimed and desired to be covered by letters patent is as follows:

1. A device, comprising:
(a) a housing member;
(b) a control mechanism connected to said housing member;
(c) a microprocessor;
(d) an air temperature measuring device;
(e) a relative humidity measuring device;
(f) an air inlet in said housing member configured to operatively expose said air temperature measuring device and said relative humidity measuring device to the ambient atmosphere; and
(g) a power source for operating said control mechanism; wherein said control mechanism is configured to operatively determine and communicate in real time to a user the ambient air temperature, the ambient relative humidity, and a heat index of the user's ambient environment to the microprocessor.

2. The device of claim 1, wherein said control mechanism includes a display mechanism operatively configured to display said heat index.

3. The device of claim 2, wherein said control mechanism further includes a display switch configured to permit manual control of said display mechanism.

4. The device of claim 3, wherein said control mechanism further includes a display switch configured to permit manual control of said display mechanism.

5. The device of claim 1, wherein said control mechanism further includes a display switch configured to permit manual control of a display mechanism.

6. The device of claim 1, wherein said control mechanism includes a signaling device configured to operatively signal the user when the ambient heat index reaches a certain predetermined condition.

7. The device of claim 6, wherein said signaling device is configured to provide an audible signal to the user.

8. The device of claim 6, wherein said signaling device is configured to provide a vibrational signal to the user.

9. The device of claim 6, wherein said signaling device is also configured to provide a vibrational signal to the user.

10. The device of claim 6, further including an attaching mechanism configured to attach said housing member to the user.

11. A device, comprising:
(a) a housing member, including an air inlet configured to operatively permit ambient air into an internal chamber of said housing member;
(b) a control mechanism connected to said housing member, said control mechanism including:
(1) a microprocessor,
(2) an air temperature measuring device, wherein said air temperature measuring device is configured to operatively determine a user's ambient air temperature from said ambient air entering said internal chamber and to communicate same real time to said microprocessor,
(3) a relative humidity measuring device, wherein said relative humidity measuring device is configured to operatively determine the user's ambient relative humidity from said ambient air entering said internal chamber and to communicate same real time to said microprocessor,
(4) a first display mechanism connected to said microprocessor and configured to display a heat index,
(5) a second display mechanism connected to said microprocessor and configured to display said ambient air temperature and said ambient relative humidity,
(6) a first display switch configured to permit manual control of said first display mechanism,
(7) a second display switch configured to permit manual control of said second display mechanism, and
(8) a signaling device configured to operatively signal the user when the combined ambient air temperature and ambient relative humidity result in a predetermined heat index calculation;
(c) a power source for operating said control mechanism;
(d) an attaching mechanism configured to attach said housing member to the user; and
(e) wherein said control mechanism is configured to operatively determine and communicate real time to the user the heat index of the user's ambient environment.
